(19) United States
(12) Patent Application Publication
(10) Pub. No.: US 2010/0251381 A1
(43) Pub. Date: Sep. 30, 2010

(54) SYSTEM RENEWABILITY MESSAGE PROVIDING METHOD AND SYSTEM RENEWABILITY MESSAGE USING METHOD AND APPARATUS THEREOF

(76) Inventors: Seong-Oun Hwang, Daejon (KR); Sangwoo Ahn, Daejon (KR); Jeho Nam, Seoul (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/673,818

(22) PCT Filed: Aug. 14, 2008
(86) PCT No.: PCT/KR08/04729

§ 371 Date: May 24, 2010

Related U.S. Application Data
(60) Provisional application No. 60/956,390, filed on Aug. 17, 2007.
(60) Provisional application No. 60/965,352, filed on Aug. 20, 2007.
(60) Provisional application No. 60/973,431, filed on Sep. 18, 2007.
(60) Provisional application No. 60/991,840, filed on Dec. 3, 2007.

(51) Int. Cl. G06F 21/00

(52) U.S. Cl. 726/26

(57) ABSTRACT

Provided are a system renewability message providing method, a system renewability message using method and an apparatus thereof. The system renewability message providing method, includes: creating system renewability message container information including revocation list information for contents protection; and defining the system renewability message container information as an International Organization for Standardization (ISO) base media file format and distributing the system renewability message container information to a terminal.

### TECHNICAL FIELD

The present invention relates to a system renewability message providing method, a system renewability message using method and an apparatus thereof.

This work was supported by the IT R&D program for MIC/IITA [2007-S-003-01, “Development of Protection Technology for Terrestrial DTV Program”].

### BACKGROUND ART

As very high-speed Internet comes into wide use and users of digital devices such as a Personal Computer (PC) and a mobile phone increase, problems associated with copyright starts differently from an environment where traditional analog contents are used. In an analog contents environment, copying contents is not easy and effective due to quality degradation. However, development of digital technology and expansion of infrastructure makes illegal copying and mass distribution of digital contents easy.

Problems associated with illegal copying are not limited only to Internet and a PC environment. As all media is being digitalized, the illegal copying and mass distribution of digital contents have become problems to be solved in both broadcasting and non-broadcasting areas.

There are Digital Rights Management (DRM) and copy protection technologies as conventional technical measures for solving these problems. However, effective solutions for preventing the illegal copying and mass distribution of digital contents are not suggested yet.

### DISCLOSURE

### Technical Problem

An embodiment of the present invention is directed to providing a method and apparatus for efficiently preventing illegal copying and mass distribution of digital contents.

Another embodiment of the present invention is directed to providing continuous integrity on a contents protection system including a broadcasting program.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a system renewability message providing method, including: creating system renewability message container information including revocation list information for contents protection; and defining the system renewability message container information as an International Organization for Standardization (ISO) base media file format and distributing the system renewability message container information to a terminal. The protected scheme information includes scheme type information including identifier information of protection scheme and scheme information including detailed information of the protection scheme.

In accordance with another aspect of the present invention, there is provided a system renewability message using method, including: receiving system renewability message container information which includes revocation list information for contents protection and is defined as an ISO base media file format; and limiting access to contents based on the received system renewability message container information. The protected scheme information includes scheme type information including identifier information of protection scheme and scheme information including detailed information of the protection scheme.

In accordance with another aspect of the present invention, there is provided a system renewability message providing apparatus, including: a creating unit for creating system renewability message container information including revocation list information for contents protection; and a transmitting unit for defining the system renewability message container information as an ISO base media file format and distributing the system renewability message container information to a terminal. The protected scheme information includes scheme type information including identifier information of protection scheme and scheme information including detailed information of the protection scheme.

In accordance with another aspect of the present invention, there is provided a system renewability message using apparatus, including: a receiving unit for receiving system renewability message container information including revocation list information for contents protection and defining the system renewability message container information as an ISO base media file format; and a limiting unit for limiting access to the contents based on the received system renewability message container information. The protected scheme information includes scheme type information including identifier information of protection scheme and scheme information including detailed information of the protection scheme.

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

### ADVANTAGEOUS EFFECTS

The present invention can efficiently prevent illegal copying and mass distribution of digital contents.

Also, the present invention provides continuous integrity on a contents protection system including a broadcasting program based on a system renewability message.

### BRIEF DESCRIPTION OF THE DRAWINGS

FIG. 1 is a block diagram showing a structure of the system renewability message container information in accordance with an embodiment of the present invention.

FIG. 2 is a block diagram showing a system renewability message providing apparatus and a system renewability message using apparatus in accordance with an embodiment of the present invention.

FIG. 3 is a block diagram showing a structure of an International Organization for Standardization (ISO) base media file used in an embodiment of the present invention.

FIG. 4 is a block diagram showing a track and sample of the ISO base media file format used in an embodiment of the present invention.

### BEST MODE FOR THE INVENTION

A specific embodiment of the present invention will be described hereafter.

### Embodiment

In the embodiment of the present invention, a method for protecting contents of International Organization for Standardization (ISO) base media file format generally used not only on the Internet but also in a broadcasting environment will be described. The contents protection method suggested in the present invention can be applied to fields using the ISO base media file format as well as a broadcasting field. In other words, the application area of the present invention is not specifically limited to a contents field.

In this embodiment, a case that the present invention protects a broadcasting program based on Digital Video Broadcasting (DVB) Content Protection and Copy Management (CPCM) in a Moving Picture Experts Group 2 Transport Stream (MPEG-2 TS) broadcasting environment will be described.

ISO base media file format [ISO/IEC 14496-12: Information technology—Coding of audio-visual objects—Part 12: ISO Base Media File Format, Second Edition, April 2005] describes a general format for other specific file formats.

A core concept of the ISO base media file format will be described in brief.

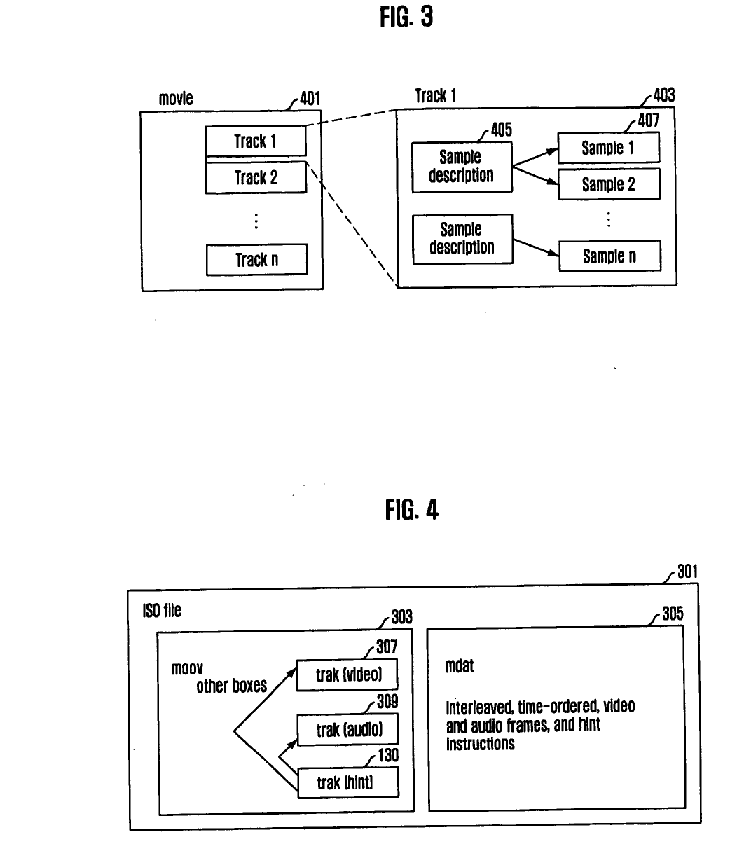

FIG. 3 is a block diagram showing a structure of the ISO base media file used in an embodiment of the present invention. Referring to FIG. 3, an ISO base media file 301 includes objects called ‘boxes 303 and 305’ and the entire data are described in the boxes.

A box object has size and type information. The size indicates the size of the data included in the box as a byte number and the type means a box identifier formed of 4 letters. Accordingly, the location of the box including desired information can be easily detected based on the size and type information.

In FIG. 3, moov 303 and mdat 305 are boxes having metadata and media data, respectively. The metadata do not include media data and are just referred to for description. The ISO base media file has a box of a ‘moov’ type including metadata on media stream and a box of a ‘mdat’ type including actual media data.

FIG. 4 is a block diagram showing a track and sample of the ISO base media file format used in an embodiment of the present invention. In FIG. 4, a movie 401 is a set of consecutive motions where video such as moving picture is integrated with audio. A track 403 shows a time flow of the media and includes a sample 407 and a sample description 405. The sample 407 means a small unit such as a frame of video and the sample description 405 defines information on how the samples 407 are decoded. There are a video track, an audio track and a hint track as the kind of tracks. The video track or the audio track includes metadata on video or audio. The hint track describes information on how a streaming server performs streaming or packetizing onto video and audio samples when the ISO base media file is streamed based on a streaming protocol. When the ISO base media file is restored, the hint track may be ignored.

MPEG is a standard protocol made by the International Standard Organization/International Electro-technical Commission (ISO/IEC) Joint Technical Committee One (JTC1) affiliated committee SC29/WG11, which is related to general technology for compressing, coding and transmitting multimedia data such as moving pictures and voice signals. MPEG-2 is a more generalized standard protocol ISO/IEC 13818 made in 1995, and it is suggested for applying the video and audio technology to communication and broadcasting media as well as storing video in digital storage such as compact disc (CD) and video tape recorder (VTR). MPEG-2 Transport Stream (TS) is a packetizing procedure of MPEG-2 for configuring a plurality of broadcasting programs into a multiplexed stream under a channel environment having an error and transmitting or broadcasting the stream through network. The MPEG TS packet is a 188-byte fixed length packet and the consecutive streams of the TS packet are called Transport Stream (TS).

A system renewability message container box is used to store a list of a system renewability message. When there is the system renewability message container box in a file, the system renewability message container box is located at the highest level of the file layer. The system renewability message container box includes a plurality of system renewability message boxes.

Cancel list information for contents protection is included in the system renewability message container box. The revocation list information includes security damaged-device identifier information or certificate information. Terminal usage on contents is limited based on the device identifier information or certificate information included in the revocation list information. The revocation list information includes identifier information on a revocation scheme and list information analyzed by the revocation scheme. When the revocation list is not installed in the system, the revocation list information includes Uniform Resource Identifier (URI) information such that the user can be connected to a web-page.

The system renewability message container box includes entry_count information on the number of the system renewability message boxes included in the system renewability message container box and the system renewability message box. For example, the system renewability message container box includes information on the number of the registered system renewability message boxes and actual system renewability message boxes.

An example syntax on system renewability message container information is as follows.

```
    aligned(8) class SRMContainerBox extends FullBox(‘srmc’,
0, flags) {
    unsigned int(32) entry_count;
    for (i=1; i<=entry_count; i++)
    SRMBox srm;
    }
```

The system renewability message box includes identifier information CP_system_id on a system where system renewability information is applied. The identifier information on the system where system renewability information is applied is information for identifying a copy protection system where the system renewability message is applied and specifies who defines a message format. The detailed format and using method of the system renewability message box are defined by a key management system of the related contents protection scheme.

An example syntax on the system renewability message box is as follows.

```
    aligned(8) class SRMBox extends FullBox(‘srmb’, 0, flags)
{
    unsigned int(16) CP_system_id;
    unsigned int(8) SystemRenewabilityMessage[ ];
    }
```

where ‘SystemRenewabilityMessage’ describes binary data of the system renewability message.

As described above, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

### MODE FOR THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, a part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like. To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

The present invention relates to a method for using a system renewability message (SRM) required for continuously maintaining integrity of a contents protection system. Generally, contents protection technology depends on security of a device key stored in a compliance device used by a final user. However, when an attacker is able to access to the security key, the security of the contents protection system is damaged. For example, the attacker is able to make a clone device which avoids security requirements while copying the compliance device.

In order to solve the problems, the present invention uses the system renewability message. The system renewability message means a set of messages for continuously securing integrity of the system. The system renewability message is created and distributed by an institute licensing the contents protection technology. For example, a revocation list such as a security damaged-device identifier list or a certificate list is included in the system renewability message. In the present invention, a file format for including the system renewability message as an International Organization for Standardization (ISO) base media file format is defined and a method using the file format is described.

The system renewability message container information includes revocation list information for contents protection, is defined as the ISO base media file format and distributed to the terminal. The revocation list information includes security damaged-device identifier information or certificate information and limits the usage of the terminal on the contents. Meanwhile, the revocation list information includes identifier information on the revocation scheme and list information analyzed by the revocation scheme.

When there is the system renewability message container information in the file, the system renewability message container information is located in the highest level of the file layer.

The system renewability message container information includes number information of the system renewability message information included in the system renewability message container information and system renewability message information. The system renewability message information includes identifier information on the system where the system renewability information is applied.

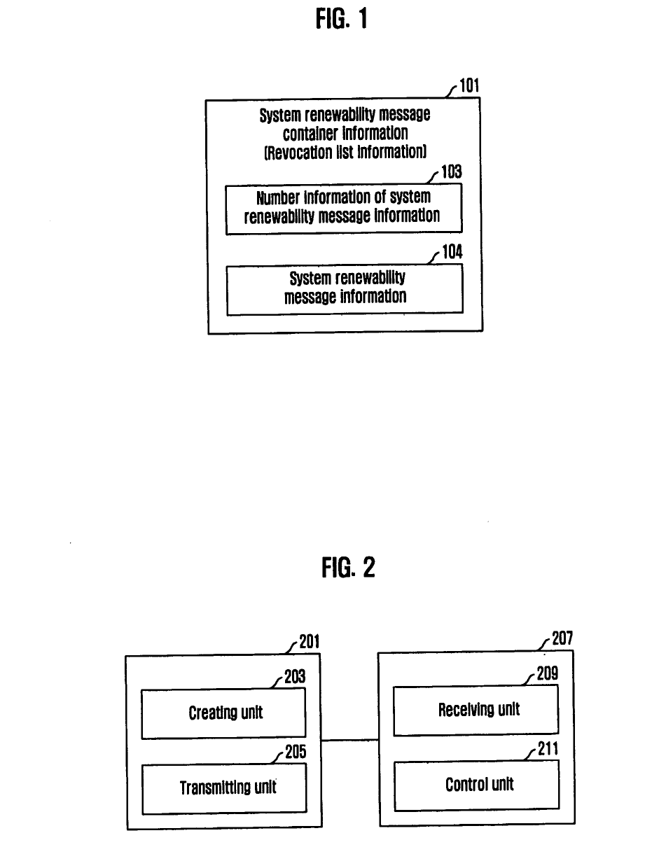

FIG. 1 is a block diagram showing a structure of the system renewability message container information in accordance with an embodiment of the present invention. As shown in FIG. 1, system renewability message container information 101 of the present invention includes revocation list information for contents protection.

The system renewability message container information 101 of the present invention is defined as the ISO base media file format. The system renewability message container information 101 limits access of the terminal to the contents.

The revocation list information includes security damaged-device identifier information or certificate information. Usage on the contents is limited based on the device identifier information or the certificate information. Meanwhile, the revocation list information includes identifier information on the revocation scheme and list information analyzed by the revocation scheme.

The system renewability message container information 101 is located in the highest level of the file. The system renewability message container information includes number information 103 of the system renewability message information included in the system renewability message container information and system renewability message information 104.

The system renewability message information 104 includes identifier information on the system where the system renewability information is applied.

The present invention is realized as methods including a system renewability message providing method and a system renewability message using method, and apparatuses including a system renewability message providing apparatus and a system renewability message using apparatus. The methods and apparatuses realized by the present invention will be described hereinafter.

<System Renewability Message Providing Method and System Renewability Message Using Method>

The present invention is realized in a system including a provider protecting contents and a terminal receiving contents.

The system renewability message providing method and the system renewability message using method respectively performed in the provider and the terminal will be described.

The system renewability message providing method of the present invention includes the procedures of creating system renewability message container information including revocation list information for contents protection and defining the system renewability message container information as the ISO base media file format and distributing the system renewability message container information to the terminal.

The revocation list information includes security damaged-device identifier information or certificate information. Usage of the terminal on the contents is limited based on the device identifier information or the certificate information. Meanwhile, the revocation list information includes identifier information on the revocation scheme and list information analyzed by the revocation scheme.

The system renewability message container information is located in the highest level of the file. The system renewability message container information includes number information of the system renewability message information included in the system renewability message container information and system renewability message information.

The system renewability message information includes identifier information on the system where the system renewability information is applied.

<System Renewability Message Providing Apparatus and System Renewability Message Using Apparatus>

The present invention is realized in a system including a provider protecting contents and a terminal receiving contents. FIG. 2 is a block diagram showing the system renewability message providing apparatus and the system renewability message using apparatus in accordance with an embodiment of the present invention. It will be described with reference to FIG. 2.

A system renewability message providing apparatus 201 of the present invention includes a creating unit 203 for creating system renewability message container information including revocation list information for contents protection and a transmitting unit 205 for defining the system renewability message container information as the ISO base media file format and distributing the system renewability message container information to the terminal.

The revocation list information includes security damaged-device identifier information or certificate information. Usage of a terminal 207 on the contents is limited based on the device identifier information or the certificate information. Meanwhile, the revocation list information includes identifier information on the revocation scheme and list information analyzed by the revocation scheme.

The system renewability message container information is located in the highest level of the file. The system renewability message container information includes number information of the system renewability message information included in the system renewability message container information and system renewability message information.

The system renewability message information includes identifier information on the system where the system renewability information is applied.

The apparatus using the system renewability message 207 includes revocation list information for contents protection of the present invention and includes a receiving unit 209 for receiving system renewability message container information defined as the ISO base media file format and a control unit 211 for limiting access to the contents based on the received system renewability message container information.

The revocation list information includes security damaged-device identifier information or certificate information. Usage on the contents is limited based on the device identifier information or the certificate information. Meanwhile, the revocation list information includes identifier information on the revocation scheme and list information analyzed by the revocation scheme.

The system renewability message container information is located in the highest level of the file. The system renewability message container information includes number information of the system renewability message information included in the system renewability message container information and system renewability message information.

The system renewability message information includes identifier information on the system where the system renewability information is applied.

### INDUSTRIAL APPLICABILITY

The present invention is applied to efficiently prevent illegal copying and mass distribution of digital contents.

Also, the present invention is applied to secure continuous integrity on a contents protection system including a broadcasting program.

1. A method for providing a system renewability message, comprising:
creating system renewability message container information including revocation list information for contents protection; and
defining the system renewability message container information as an International Organization for Standardization (ISO) base media file format and distributing the system renewability message container information to a terminal.

2. The method of claim 1, wherein the revocation list information includes security damaged-device identifier information or certificate information.

3. The method of claim 2, wherein use of the terminal for the contents is limited based on the device identifier information or the certificate information.

4. The method of claim 1, wherein the system renewability message container information is located in a highest level of a file.

5. The method of claim 1, wherein the system renewability message container information includes number information of system renewability message information included in the system renewability message container information and the system renewability message information.

6. The method of claim 5, wherein the system renewability message information includes identifier information on a system where the system renewability information is applied.

7. The method of claim 1, wherein the revocation list information includes:
identifier information on a revocation scheme and list information analyzed by the revocation scheme.

8. A method for using a system renewability message, comprising:
receiving system renewability message container information which includes revocation list information for contents protection and is defined as an International Organization for Standardization (ISO) base media file format; and
limiting access to contents based on the received system renewability message container information.

9. The method of claim 8, wherein the revocation list information includes security damaged-device identifier information or certificate information.

10. The method of claim 9, wherein use of the contents is limited based on the device identifier information or the certificate information.

11. The method of claim 8, wherein the system renewability message container information is located in a highest level of a file.

12. The method of claim 8, wherein the system renewability message container information includes number information of system renewability message information included in the system renewability message container information and the system renewability message information.

13. The method of claim 12, wherein the system renewability message information includes identifier information on a system where the system renewability information is applied.

14. The method of claim 8, wherein the revocation list information includes identifier information on a revocation scheme and list information analyzed by the revocation scheme.

15-28. (canceled)
